(19) United States
(12) Patent Application Publication
(10) Pub. No.: US 2015/0103358 A1
(43) Pub. Date: Apr. 16, 2015

(54) SYSTEM AND METHOD FOR NON-CONTACT MEASUREMENT OF 3D GEOMETRY

(71) Applicant: Galil Soft Ltd., Kfar Vradim (IL)

(72) Inventor: Ittai Flascher, Kfar Vradim (IL)

(21) Appl. No.: 14/382,467

(22) PCT Filed: Mar. 6, 2013
(86) PCT No.: PCT/IL2013/050208

§ 371 Date: Sep. 2, 2014

Related U.S. Application Data
(60) Provisional application No. 61/608,827, filed on Mar. 9, 2012.

(51) Int. Cl. G01B 11/25

(52) U.S. Cl. CPC G01B 11/25
USPC 356/603

(57) ABSTRACT

A method for the non-contact measurement of a scene's 3D geometry is based on the concurrent projection of multiple and overlapping light patterns of different wavelengths and/or polarity onto its surfaces. Each location in the overlapping light patterns is encoded (code-word) by the combined arrangements of code elements (code-letters) from one or more of the overlapping patterns. The coded light reflected from the scene is imaged separately for each wavelength and/or polarity by an acquisition unit and code-letters are combined at each pattern location to yield a distinct code-word by a computing unit. Code-words are then identified in the image, stereo-matched, and triangulated, to calculate the range to the projected locations on the scene's surface.

### FIELD OF THE INVENTION

The subject matter of the current application relates to a system and measurement methods for reconstructing three-dimensional objects based on the projection and detection of coded structured light patterns.

### BACKGROUND OF THE INVENTION

This invention pertains to the non-contact measurement of three-dimensional (3D) objects. More particularly, the invention relates to measurement methods based on the projection and detection of patterned light to reconstruct (i.e. determine) the 3D shape, size, orientation, or range, of material objects, and/or humans (hereinafter referred to as “scenes”). Such methods, known as “active triangulation by coded structured light” (hereinafter referred to as “structured light”), employ one or more light projectors to project onto the surfaces of the scene one or more light patterns consisting of geometric shapes such as stripes, squares, or dots. The projected light pattern is naturally deformed by the 3D geometry of surfaces in the scene, changing the shapes in the pattern, and/or the relative position of shapes within the pattern as compared with the one that emanated from the projector. This relative displacement of shapes within the projected pattern is specific to the 3D geometry of the surface and therefore implicitly contains information about its range, size, and shape. The light pattern reflected from the scene is then captured as an image by one or more cameras with some known relative pose (i.e. orientation and location) with respect to the projector and analyzed by a computer to extract the 3D information. A plurality of 3D locations on the surface of the scene are determined through a process of triangulation: the known disparity (line-segment) between the location of a shape within the projector's pattern and its location within the camera's image plane defines the base of a triangle; the line-segment connecting the shape within the projector with that shape on a surface in the scene defines one side of that triangle; and the other side of the triangle is given by the line-segment connecting the shape within the camera's image plane and that shape on the surface; range is then given by solving for the height of that triangle where the base-length, projector angles, and camera angles are known (by design, or through a calibration process).

Structured light methods therefore require that the shape projected on a surface in the scene be identified (matched) and located within the projector and camera's image planes. However, to determine the 3D shape of a significant portion of the scene in some detail, the pattern must contain a plurality of shapes. Consequently, shapes in the pattern must be distinctly different from one another to help in guaranteeing that every feature (shape) projected by the projector is correctly identified in the image detected by the camera, and therefore, that the triangulation calculation is a valid measurement of range to the surface at the projected shape's location (i.e. the correspondence problem). The main challenges that structured light methods must overcome are then to create patterns that contain as many distinct shapes as possible and to minimize their size; thus increasing the reliability, spatial resolution, and density, of the scene's reconstruction.

One approach taken to overcome these challenges is known as “time-multiplexing”: Multiple patterns are projected sequentially over time and a location on a surface is identified by the distinct sequence of shapes projected to that location. Reconstruction techniques based on this approach, however, may yield indeterminate or inaccurate measurements when applied to dynamic scenes, where objects, animals, or humans may move before the projection sequence has been completed.

Another approach, known as “wavelength-multiplexing” overcomes the above challenges by using patterns containing shapes of different colors. This added quality allows for more geometric shapes to become distinguishable in the pattern. However, this approach may not lead to a denser measurement (i.e. smaller shapes, or smaller spacing) and may lead to indeterminate or incorrect measurements in dimly lit scenes and for color-varying surfaces.

Another approach, known as “spatial-coding”, increases the number of distinguishable shapes in the pattern by considering the spatial arrangement of neighboring shapes (i.e. spatial configurations).

FIG. 1 depicts one such exemplary pattern 700, which is but a section of the pattern projected, comprising two rows (marked as Row 1 and 2) and three columns (marked as Column 1 to 3) of alternating black (dark) and white (bright) square cells (primitives) arranged in a chessboard pattern. Thus, cell C(1,1) in Row 1 and Column 1 is white, cell C(1,2) in Row 1 and Column 2 is black, etc. In each of the six cells, one corner (i.e. vertex) of the square primitive is replaced with a small square (hereinafter referred to as an “element”); In Row 1, the lower-right corner, and in Row 2, the upper-left corner. Elements may be configured to be either black or white and constitute a binary code-letter for each cell. Distinguishable pattern shapes—code-words may then be defined by the arrangement (order) of element colors (dark or bright) in, say, six neighboring cells (2 rows×3 columns coding-window), yielding 2⁶=64 different shapes (i.e. coding index-length).

The spatial-coding approach, however, has a few possible drawbacks. The relatively small number of code-words yielded by spatial-coding methods may span but a small portion of the imaged scene, which may lead to code-words being confused with their repetitions in neighboring parts of the pattern. Furthermore, the need for a spatial span (neighborhood) of multiple cells to identify a code-word makes measurements of the objects' boundaries difficult as a code-word may be partially projected on two different objects separated in depth. For the same reason, the minimal size of an area on a surface that can be measured is limited to the size of a full coding-window. Improvements to spatial-coding methods have been made over the years, increasing the number of distinct code-words and decreasing their size (see, Pajdla, T. BCRF—Binary illumination coded range finder: Reimplementation. ESAT MI2 Technical Report Nr. KUL/ESAT/MI2/9502, Katholieke Universiteit Leuven, Belgium, April 1995; Gordon, E. and Bittan, A. 2012, U.S. Pat. No. 8,090,194). However, the aforementioned limitations are inherent in the spatial-coding nature of structured-light approaches, irrespective of the geometric primitives used and how they are arranged, and therefore cannot be overcome completely.

Consequently, commercial applications using non-contact 3D modeling and measurement techniques such as manufacturing inspection, face recognition, non-contact human-machine-interfaces, computer-aided design, motion tracking, gaming, and more, would benefit greatly from a new approach that improves 3D measurement resolution, density, reliability, and robustness against surface discontinuities.

### SUMMARY OF THE INVENTION

The subject matter of the present application provides for a novel light-pattern codification method and system—“pattern overlaying”. A plurality of, at least partially overlapping, light-patterns are projected simultaneously, each with a different wavelength and/or polarity. The patterns reflected from the scene are then captured and imaged by sensors sensitive to the projected patterns' different light wavelength/polarity, and pattern locations are identified by the combined element arrangements of the overlapping patterns.

More explicitly, the projected beam, projected by projection unit 15 (FIG. 2B) comprises for example three patterns (Pattern 1, Pattern 2 and Pattern 3), created by the different masks 3× respectively, and each with a different wavelength. The three patterns are projected concurrently onto the scene by projection unit 15 such that the corresponding cells are overlapping.

FIG. 4 depicts a specific embodiment of the pattern-overlaying codification approach using three such overlapping patterns. In this figure only three cells (cells 1, 2, and 3) of one row (Row 1) of the entire projected pattern are shown one above the other. That is: cell c(1,1/1) which is the Cell 1 of Row 1 in Pattern 1 is overlapping Cell c(1,1/2), which is the Cell 1 of Row 1 in Pattern 2, and both overlap Cell c(1,1/3) which is the Cell 1 of Row 1 in Pattern 3, etc.

Each pattern cell c(y,x/p) comprises a plurality of subunits (coding elements), in this exemplary case, an array of 3×3=9 small squares S(y,x/p,j) (e.g. pixels) where “y”, “x”, and “p” are row, cell, and pattern indices respectively, and “j” is the index of the small square (element) (j=1, 2, 3, . . . , 9 in the depicted embodiment).

Decoding (identifying and locating) cells in the imaged patterns (to be matched with the projected pattern and triangulated) may then be achieved by a computing unit executing an instruction set. For example, cells may be identified by the combined arrangement of elements (code-letters) of two or more overlapping patterns as follows. Considering, for clarity, only four cell elements—small squares located at the cell's corners, such as the four small squares S(1,1/1,1), S(1,1/1,3), S(1,1/1,7), and S(1,1/1,9) in Cell(1,1/1), a code-word for Cell 1 in FIG. 4 could be given by the sequence of binary element values (dark=0, bright=1) of three patterns overlapping in that cell: {0,1,0,0,0,1,1,0,1,1,1,0}, with the element order of {S(1,1/1,1), S(1,1/1,3), S(1,1/1,7), S(1,1/3,9), S(1,1/2,1), S(1,1/2,3), S(1,1/2,7), S(1,1/2,9), S(1,1/3,1), S(1,1/3,3), S(1,1/3,7), S(1,1/3,9)}.

More generally, it is one aspect of the current invention to provide a method for non-contact measurement of 3D geometry, the method comprising:
concurrently generating a plurality of structured patterns of light, wherein each of said patterns of light is substantially characterized by at least one different parameter selected from a group consisting of wavelength and polarization state, and wherein said patterns of light are structured to encode a plurality of locations on said patterns of light, based on the combination of arrangements of elements' intensities of said patterns of light;
projecting said plurality structured patterns of light onto at least a portion of a surface of a scene such that said plurality of structured patterns of light at least partially overlap on said surface;
reflecting at least a portion of said plurality structured patterns of light off said portion of said surface of said scene;
capturing at least a portion of the light reflected off said portion of said surface of said scene;
guiding portions of the captured light to a plurality of imaging sensors, wherein each of said plurality of imaging sensors is sensitive to light substantially characterized by one of said different parameter;
concurrently imaging light received by said imaging sensors;
decoding at least a portion of said plurality of locations on said patterns of light based on the combination of arrangements of elements' intensities of the imaged patterns of light.
reconstructing a 3D model of said surface of said scene based on triangulation of the decoded locations on said patterns of light.

It is another aspect of the current invention to provide a system (100) for non-contact measurement of 3D geometry, the system comprising:
a projection unit that is capable of projecting concurrently onto a surface (77) of a scene (7) a plurality structured patterns of light, wherein said patterns of light are: at least partially overlapping, and wherein each of said patterns of light is substantially characterized by at least one different parameter selected from a group consisting of:
wavelength and polarization state,
and wherein said patterns of light are structured to encode a plurality of locations on said patterns of light, based on the combination of arrangements of elements' intensities of said patterns of light;
a light acquisition unit capable of concurrently capturing separate images of the different light patterns reflected from said surface of said scene; and
a computing unit which is capable of processing said images captured by the light acquisition unit and decoding at least portion of said plurality of locations on said patterns of light based on the combination of arrangements of elements' intensities of said patterns of light, and reconstructing a 3D model of said surface of said scene based on triangulation of the decoded locations on said patterns of light.

As made explicit below, different possible embodiments of the subject matter of the present application may allow for advantageously small coding-windows (i.e. a single cell or a fraction thereof) and a large coding index (e.g. 2¹²=4,096, in the example depicted in FIG. 4 employing three overlapping patterns and four elements). Those in turn may translate into dense measurements, high spatial resolution, small radius-of-continuity (i.e. the minimal measureable surface area), and robustness against surface discontinuities (e.g. edges).

In some embodiments, the projection unit comprises:
a plurality of projectors, wherein each of said projectors is capable of generating a corresponding structured light beam, and wherein each of said structured light beam is characterized by at least one different parameter selected from a group consisting of:
wavelength and polarization state,
a beam combining optics, capable of combining said plurality of structured light beams into a combined pattern beam; and a projection lens capable of projecting said combined pattern beam onto at least a portion of the surface of said scene.

In some embodiments, each of said plurality of projectors comprises:
a light source;
a collimating lens capable of collimating light emitted from said light source; and
a mask capable of receiving light collimated by said collimated light and producing said structured light beam.

In some embodiments, each of said plurality of light sources has a distinctive wavelength.

In some embodiments, each of said plurality of light sources is a laser.

In some embodiments, each of said plurality of light sources is an LED.

In some embodiments, each of said plurality of light sources is a lamp.

In some embodiments, each of said plurality of light sources is capable of producing a pulse of light, and said plurality of light sources are capable of synchronization such that pulses emitted from said light sources overlap in time.

In some embodiments, said plurality of locations is coded by the combination of element intensity arrangements of a plurality of overlapping patterns.

In some embodiments, said plurality of locations is coded by the sequence of element intensity values of a plurality of overlapping patterns.

In some embodiments, the light acquisition unit comprises:
an objective lens capable of collecting at least a portion of the light reflected from said surface of said scene;
a plurality of beam-splitters capable of splitting the light collected by said objective lens to separate light-patterns according to said parameter selected from a group consisting of:
wavelength and polarization state, and capable of directing each of said light-patterns onto the corresponding imaging sensor; and
a plurality of imaging sensor, each capable of detecting the corresponding light-patterns,
and capable of transmitting an image to said computing unit.

In some embodiments, each of said plurality of adjacent pattern cells is entirely illuminated by at least one, or a combination, of the overlapping patterns of different wavelengths and/or polarity.

In some embodiments, the beam-splitters are dichroic beam splitters capable of separating said light-patterns according to their corresponding wavelength.

In some embodiments, the wavelengths of said light-patterns are in the Near Infra Red range.

In a different embodiment, the projection unit comprises:
a broad spectrum light source capable of producing a beam having a broad spectrum of light;
a beam separator capable of separating light from said broad spectrum light source to a plurality of partial spectrum beams, wherein each partial spectrum beam is having a different wavelength range;
a plurality of masks, wherein each mask is capable of receiving a corresponding one of said partial spectrum beams, and capable of structuring the corresponding one of said partial spectrum beams producing a corresponding coded light beam;
a beam combining optics capable of combining the plurality of coded structured light beams, into a combined beam where patterns at least partially overlap; and
a projection lens capable of projecting said combined pattern beam onto at least a portion of the surface of said scene.

In yet another embodiment of the current invention, the projection unit comprises a broad spectrum light source capable of producing a beam having a broad spectrum of light;
at least one multi-wavelength mask, said multi-wavelength mask is capable of receiving the broad spectrum light from said broad spectrum light source, and capable of producing multi-wavelength coded structured light beam of light by selectively removing from a plurality of locations on the beam light of specific wavelength range, ranges; and
a projection lens capable of projecting said combined pattern beam onto at least a portion of the surface of said scene.

For example, a multi-wavelength mask may be made of a mosaic-like structure of filter sections, wherein each section is capable of transmitting (or absorbing) light in a specific wavelength range, or in a plurality of wavelength ranges. Optionally, some sections may be completely transparent or opaque. Optionally some sections may comprise light polarizers. Optionally, the multi-wavelength mask may be made of a plurality of masks, for example a set of masks, wherein each mask in the set is capable of coding a specific range of wavelength.

In some embodiments, each of said plurality of structured patterns of light is characterized by a different wavelength.

According to one possible embodiment, the number of distinguishably different code-words can be increased by increasing the number of wavelength-specific light-patterns beyond three.

In some embodiments, the plurality of structured patterns of light comprise at least one row or one column of cells, wherein each cell is coded by a different element arrangement from its neighboring cells.

In some embodiments, each one of said plurality of cells is coded by a unique element arrangement.

In some embodiments, the plurality of structured patterns of light comprises a plurality of rows of cells.

In some embodiments, the plurality of rows of cells are contiguous to create a two dimensional array of cells.

In some embodiments, one or more of the at least partially overlapping patterns are shifted relative to those of one or more of the other patterns, each of said plurality of structured patterns of light is characterized by a different wavelength.

In some embodiments, at least one of the patterns consists of continuous shapes, and at least one of the patterns consists of discrete shapes.

In some embodiments, the discrete elements of different patterns jointly form continuous pattern shapes.

In other embodiments, the requirement for a dark/bright chessboard arrangement of elements is relaxed in one or more of the overlapping images to increase the number of distinguishable code-words in the combined pattern.

In some embodiments, at least one of the projected patterns may be coded not only by “on” or “off” element values, but also by two or more illumination levels such as “off”, “half intensity”, and “full intensity”. When multilevel coding is used with one wavelength, the identification of the level may be difficult due to variations in the reflectivity of the surface of the object, and other causes such as dust, distance to the object, orientation of the object's surface, etc. However, when at least one of the wavelengths is at its maximum intensity and assuming that the reflectance at all wavelengths is identical or at least close, the maximum intensity may be used for calibration. This assumption is likely to be true for wavelengths that are close in value. Optionally, using narrowband optical filters in the camera allows using wavelengths within a narrow range. Such narrowband optical filter may also reduce the effect of ambient light that acts as noise in the image.

In other embodiments, code elements (e.g. small squares) within at least some of the cells are replaced by shapes other than squares such as triangles, dots, rhombi, circles, hexagons, rectangles, etc. Optionally, the shape of the cells is non-rectangular. Using different element shapes in one or more of the overlapping patterns, allows for a substantial increase in the number of distinguishable arrangements within a pattern-cell, and therefore, for a larger number of code-words.

In other embodiments, cell primitives (shapes) are replaced in one or more of the overlapping patterns by shapes containing a larger number of vertices (e.g. hexagon) allowing for a larger number of elements within a cell, and therefore, for a larger number of code-words.

In other embodiments, cell-rows in the different patterns are shifted relative to one another—for example, displaced by the size of an element-width, thereby allowing the coding of cells in the first pattern as well as cells positioned partway between the cells of the first pattern (FIG. 5A). The above mentioned cell-shifting can therefore yield a denser measurement of 3D scenes. Alternatively, rows are not shifted, but rather the decoding-window is moved during the decoding phase (FIG. 5B).

In other embodiments, the subject matter of the present application is used to create an advanced form of a line-scanner In these embodiments, the projected image comprises a single or a plurality of narrow stripes separated by un-illuminated areas. The projected stripe is coded according to the pattern-overlying approach to enable unambiguous identification of both the stripe (since a plurality of stripes are used), as well as locations (e.g. cells) along the stripe. A stripe may be coded as a single row or a single column or few (for example two or more) adjacent rows or columns Range measurement scanners using continuous shapes, such as stripes, to code light patterns, may offer better range measurement accuracy than those using discrete shapes to measure continuous surfaces. However, they may be at a disadvantage whenever surfaces are fragmented or objects in the scene are separated in depth (e.g. an object partially occluded by another). The subject matter of the current application enables the creation of line-scanners, as well as area-scanners, that provide the advantages of continuous shapes coding, yet avoid their disadvantages by simultaneously coding discrete cells in the following manner. Patterns are configured such that all the elements and primitive shape of a cell are of the same color (hereinafter referred to as solid cells) either within a single pattern, and/or as a result of considering a plurality of overlapping arrangements as a single code-word.

Solid cells of the same color (e.g. bright) may be positioned contiguously in the patterns to span a row, a column, or a diagonal, or a part thereof—forming a continuous stripe. Similarly, stripes may be configured to span the pattern area or parts thereof to form an area-scanner Importantly, each cell in a stripe or an area maintains a distinguishable arrangement (code-word) and may be measured (i.e. decoded and triangulated) individually (discretely).

In other embodiments, different light polarization states, for example linear, circularly, or elliptical polarizations are used in the projection of at least some of the light-patterned instead of wavelength, or in combination with wavelength. For example, each light-pattern of a given wavelength may be projected twice (simultaneously), each with an orthogonal polarization. Therefore, in the present example the number of code-words is advantageously doubled, allowing for measurements that are more robust (reliable) against decoding errors if a given index is repeated in the pattern (i.e. a larger pattern area where a cell's index is unique). Furthermore, polarized light may be better suited for measuring the 3D geometry of translucent, specular, and transparent materials such as glass, and skin. (See e.g. Chen, T. et. al., Polarization and Phase-Shifting for 3D Scanning of Translucent Objects. IEEE Conference on Computer Vision and Pattern Recognition, 2007. CVPR '07, June; http://www.cissitedu/˜txcpci/cvpr07-scan-chen_cvpr07_scan.pdf). Therefore, the present embodiment can provide a more accurate and more complete (i.e. inclusive) reconstruction of scenes containing such materials.

In other embodiments, at least partially overlapping patterns of different wavelengths are projected in sequence rather than simultaneously, yielding patterns of different wavelengths that overlap cells over time. Such an embodiment may be advantageously used, for example, in applications for which the amount of projected energy at a given time or specific wavelengths must be reduced due for example to economic or eye-safety considerations.

One possible advantage of the current system and method is that they enable the 3D reconstruction of at least a portion of a scene at a single time-slice (i.e. one video frame of the imaging sensors), which makes it advantageously effective when scenes are dynamic (i.e. containing for example moving objects or people).

Another possible advantage of the present system and method is that they require a minimal area in the pattern (i.e. a single cell). Therefore, the smallest surface region on the surface 77 of scene 7 that can be measured by using the present coding method may be smaller than those achieved by using coding methods of prior art. Using the present coding method therefore allows for measurements up to the very edges 71x of the surface 77, while minimizing the risk of mistaken or undetermined code-word decoding.

Furthermore, larger coding-windows may be partially projected onto separate surfaces, separating a cell from its coding neighborhood, and therefore, may prevent the measurements of surface edges. Using the present coding method therefore possibly allows for measurements up to the very edges of surfaces while potentially minimizing the risk of mistaken or undetermined code-word decoding.

Another advantage is that the number of distinct code-words enabled per given area by the current coding method is potentially substantially larger than the ones offered by coding methods of prior art. Therefore, the measurement-density obtainable in accordance with the exemplary embodiment of the current invention is possibly higher, which may enable, for example, measuring in greater detail surfaces with frequent height variations (i.e. heavily “wrinkled” surface).

According to the current invention, there are many ways to encode pattern locations using the plurality of patterns. Few exemplary patterns are listed herein. By analysis of the images detected by the different sensors 11x of light acquisition unit 16 (FIG. 2B), a unique code, and thus a unique location in the pattern may be associated to a single cell, even without analysis of its neighboring cells. Thus, the range to the surface of scene 7 may be determined at the location of the identified cell. Optionally, methods of the art that use information from neighboring cells may be applied to increase the reliability in resolving uncertainties brought about by signal corruption due to optical aberrations, reflective properties of some materials, etc.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 depicts an exemplary projected pattern coded according to the known art of spatial-coding.

FIG. 2A schematically depicts a method for non-contact measurement of 3D scene according to an exemplary embodiment of the current invention.

FIG. 2B schematically depicts a system for non-contact measurement of a 3D scene according to an exemplary embodiment of the current invention.

FIG. 3A schematically depicts an initial (un-coded) pattern used as the first step in creating a coded pattern.

FIG. 3B schematically depicts the coding of a cell in a pattern by the addition of at least one element to the cell according to an exemplary embodiment of the current invention.

FIG. 3C schematically depicts a section 330 of un-coded (Initial) pattern 1 shown in FIG. 3A with locations of coding elements shaped as small squares according to an exemplary embodiment of the current invention.

FIG. 3D schematically depicts a section 335 of coded pattern 1 shown in FIG. 3C according to an exemplary embodiment of the current invention.

FIG. 4 schematically depicts a section of three exemplary overlapping patterns used in accordance with an embodiment of the current invention.

FIG. 5A schematically depicts a section of three exemplary patterns used in accordance with another embodiment of the current invention.

FIG. 5B schematically depicts a different encoding of a section of an exemplary pattern used in accordance with another embodiment of the current invention.

FIG. 6 schematically depicts another exemplary pattern used in accordance with an embodiment of the current invention.

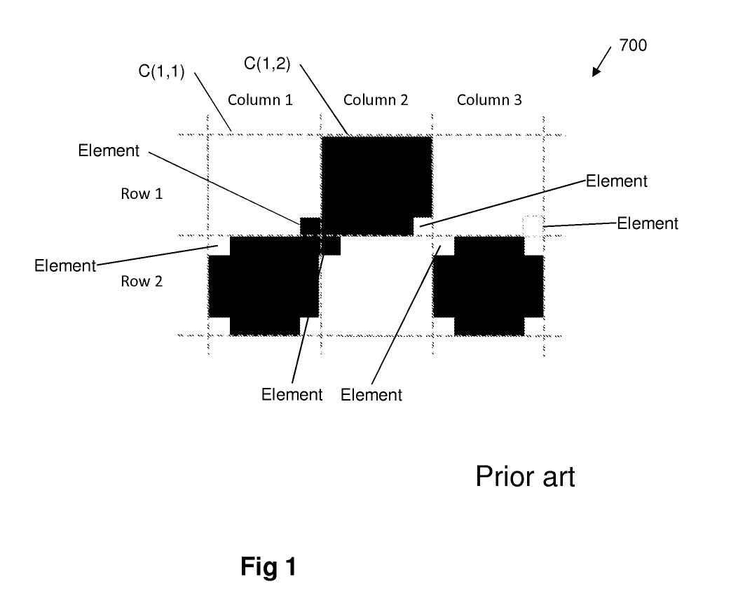

### DETAILED DESCRIPTION OF THE INVENTION

Before explaining at least one embodiment of the invention in detail, it is to be understood that the invention is not necessarily limited in its application to the details set forth in the following description or exemplified by the examples. The invention is capable of other embodiments or of being practiced or carried out in various ways.

The terms “comprises”, “comprising”, “includes”, “including”, and “having” together with their conjugates mean “including but not limited to”.

The term “consisting of has the same meaning as “including and limited to”.

The term “consisting essentially of means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

In discussion of the various figures described herein below, like numbers refer to like parts. The drawings are generally not to scale. For clarity, non-essential elements were omitted from some of the drawing.

Embodiments of the current invention provide for the non-contact measurement of 3D geometry (e.g. shape, size, range, etc.) of both static and dynamic 3D scenes such as material objects, animals, and humans. More explicitly, the subject matter of the current application relates to a family of measurement methods of 3D geometry based on the projection and detection of coded structured light patterns (hereinafter referred to as “light-patterns”).

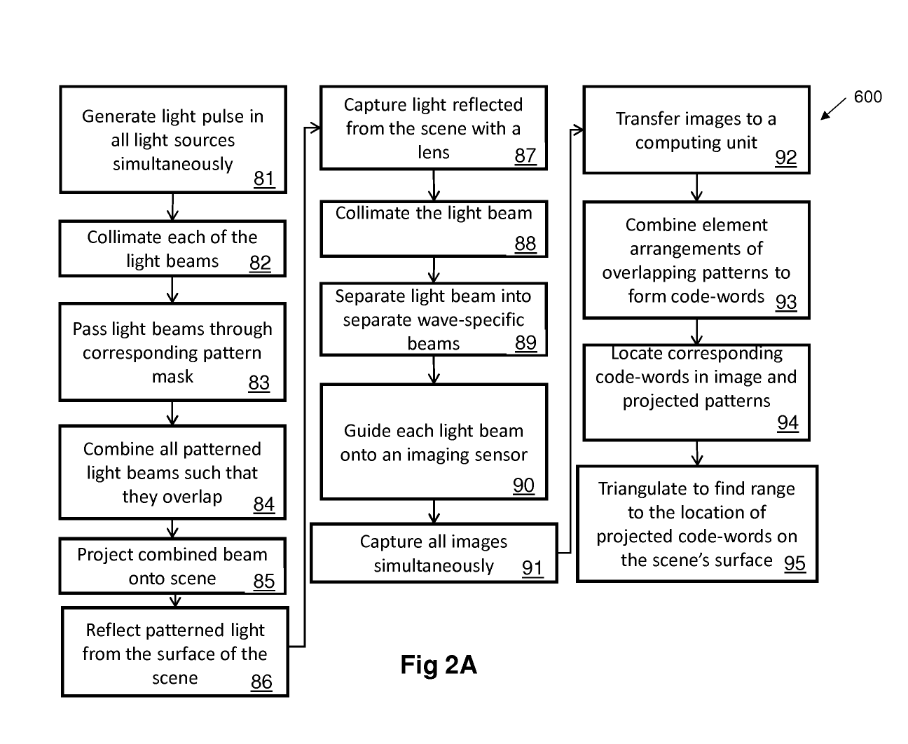

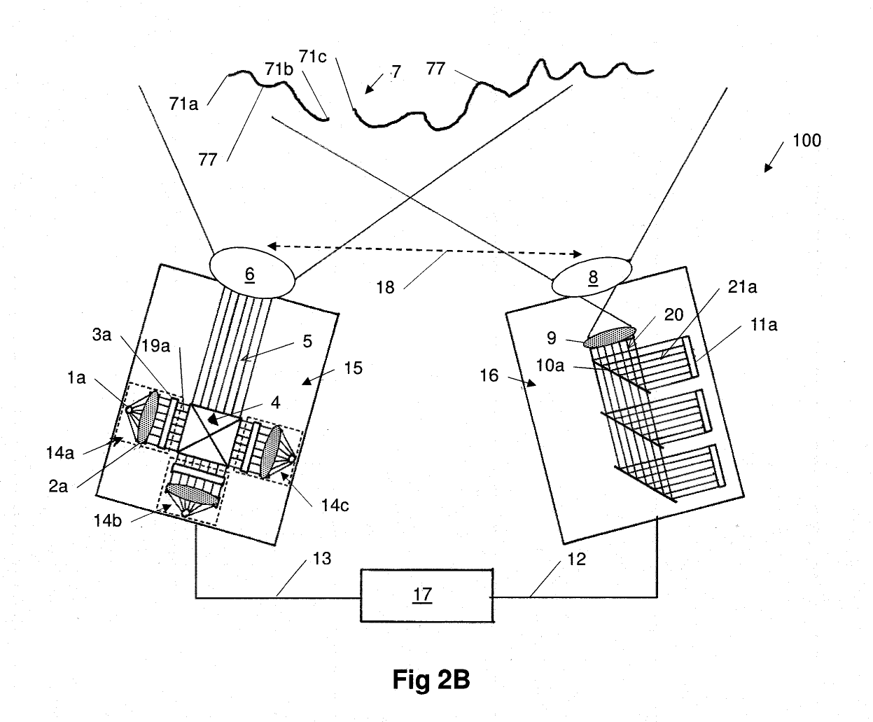

FIG. 2A schematically depicts a method 600 for non-contact measurement of 3D scene according to an exemplary embodiment of the current invention.

Method 600 comprises the following steps:
Generate light pulses in all light sources simultaneously 81, each of a different state such as wavelength. This step is performed by light sources 1x which are simultaneously triggered by the computing unit 17 via communications line 13 (shown in FIG. 2B). In this document the letter “x” stands for the letters “a”, “b”, etc. to indicate a plurality of similar structures marked collectively.
Collimate each of the light beams 82. This step is performed by collimating lens 2x.
Pass each of the collimated light beams 83 from step 82 through its corresponding pattern mask 3x.
Combine all patterned light beams 84 from step 83 so they are aligned and overlap in combined patterned beam 5. This step is performed by the beam combining optics 4 (the patterned beam and the optics are shown in FIG. 2B).
Project the combined beam 85 onto the scene 7 using projection lens 6 (the scene and the lens are shown in FIG. 2B).
Reflect patterned light 86 from the surface 77 of the scene 7 (the surface is shown in FIG. 2B).
Capture light reflected from the scene 7, 87 with objective lens 8 (the lens is seen in FIG. 2B)
Collimate the captured light 88 into collimated beam 20 using the collimating lens 9 (the beam and the lens are shown in FIG. 2B).
Separate 89 the collimated light beam 20 into separate wavelength-specific light-patterns 21x using beam-splitters 10x.
Guide 90 each wavelength-specific light-patterns 21x onto the corresponding imaging sensor 11x, which is sensitive to the corresponding wavelength.
Capture all images simultaneously 91 using imaging sensors 11x.
Transfer 92 the captured images from sensors 11x to computing unit 17 for processing (the computing unit is shown in FIG. 2B).
Combine element arrangements of a corresponding cell in all images 93 into a code-word using an instruction set executed by computing unit 17.
Locate corresponding cells in image and projector patterns 94 using an instruction set executed by computing unit 17.
Triangulate to find locations of surface 77 of scene 7, 95, which reflects light corresponding to each of the cells located in step 94 using an instruction set executed by computing unit 17.

FIG. 2B schematically depicts a system 100 for non-contact measurement of 3D scene 7 according to an exemplary embodiment of the current invention.

According to the depicted exemplary embodiment, system 100 for non-contact measurement of 3D scene geometry comprises: a projection unit 15 emitting multiple overlapping light-patterns of different wavelengths simultaneously; a light acquisition unit 16 for simultaneously capturing images of the light-patterns reflected from the scene 7; and a computing unit 17 for processing the images captured by the light acquisition unit 16 and reconstructing a 3D model of the scene 7.

System 100 is configured to perform a method 600 for non-contact measurement of 3D geometry for example as depicted in FIG. 2A.

Projection unit 15 comprises a plurality of projectors 14x. In the depicted exemplary embodiments, three such projectors 14a, 14b and 14c are shown. For drawing clarity, internal parts of only one of the projectors are marked in this figure. Pulses of light are generated in each of the projectors 14x by light sources 1x. Light source 1x may be a laser such as the Vertical-Cavity Surface-Emitting Laser (VCSEL). Each light source 1x emits light of a different wavelength from the other light sources. Wavelengths can be in the Near-Infrared spectrum band (NIR). For example, light sources 1a, 1b and 1c may emit light with a wavelength of 808 nm, 850 nm, and 915 nm respectively, and thus, they are neither visible to humans observing or being part of the scene, nor are they visible to color cameras that may be employed to capture the color image of surfaces 77 in the scene 7 to be mapped onto the reconstructed 3D geometric model.

Light from each light source 1x is optically guided by a collimating lens 2x to a corresponding mask 3x. Mask 3x may be a diffractive mask forming a pattern. Each of the light-beams 19x patterned by passing through the corresponding mask 3a, is then directed to a beam combining optics 4. Beam combining optics 4 may be an X-cube prism capable of combining the plurality of patterned beams 19x into a combined pattern beam 5. As masks 3x are different from each other, each patterned beam 19x is having a different wavelength and is differently patterned. Beam combining optics 4 redirects all the light-beams 19x coming from the different light sources 14x as a single combined patterned beam 5 to the projection lens 6, which projects the light-patterns onto at least a portion of the surface 77 of scene 7. Consequently, the combined light-patterns overlap and are aligned within the beam projected onto the scene 7. The optional alignment of the projected light-patterns of the different wavelengths due to the use of a single projection lens 6 for all the wavelengths ensures that the combined light-pattern is independent of the distance between the surface 77 of scene 7 from the projection lens 6. In contrast, using a separate and spatially displaced projector for each wavelength would cause the patterns of the different wavelength to change their relative position as a function of distance from the projectors.

The light-patterns reflected from the scene can be captured by light acquisition unit 16. Light acquisition unit 16 comprises a camera objective lens 8 positioned at some distance 18 from the projection unit 15. Light captured by objective lens 8 is collimated by a collimating lens 9. According to the current exemplary embodiment, the collimated beam 20 then goes through a sequence of beam-splitters 10x that separate the collimated beam 20 and guide the wavelength-specific light-patterns 21x onto the corresponding imaging sensor 11x. For drawing clarity, only one of each of: beam-splitters 10a; wavelength-specific light-patterns 21a; and imaging sensors 10a are marked in this drawing. In the exemplary embodiment, three beam splitters 10x are used, corresponding to the three light sources 1x having three different wavelengths. In the depicted embodiment, beam-splitters 10x are dichroic mirrors, capable of reflecting the corresponding wavelength of one of the light-sources 1x. According to the depicted exemplary embodiment, sensors 10a are video sensors such as charge-coupled device (CCD).

Preferably, all imaging sensors 11x are triggered and synchronized with the pulse of light emitted by light sources 1x by the computing unit 17 via communications lines 13 and 12 respectively, to emit and to acquire all light-patterns as images simultaneously. It should be noted that the separated images and the patterns they contain overlap. The captured images are then transferred from the imaging sensors 11x to the computing unit 17 for processing by a program implementing an instruction set, which decodes the patterns.

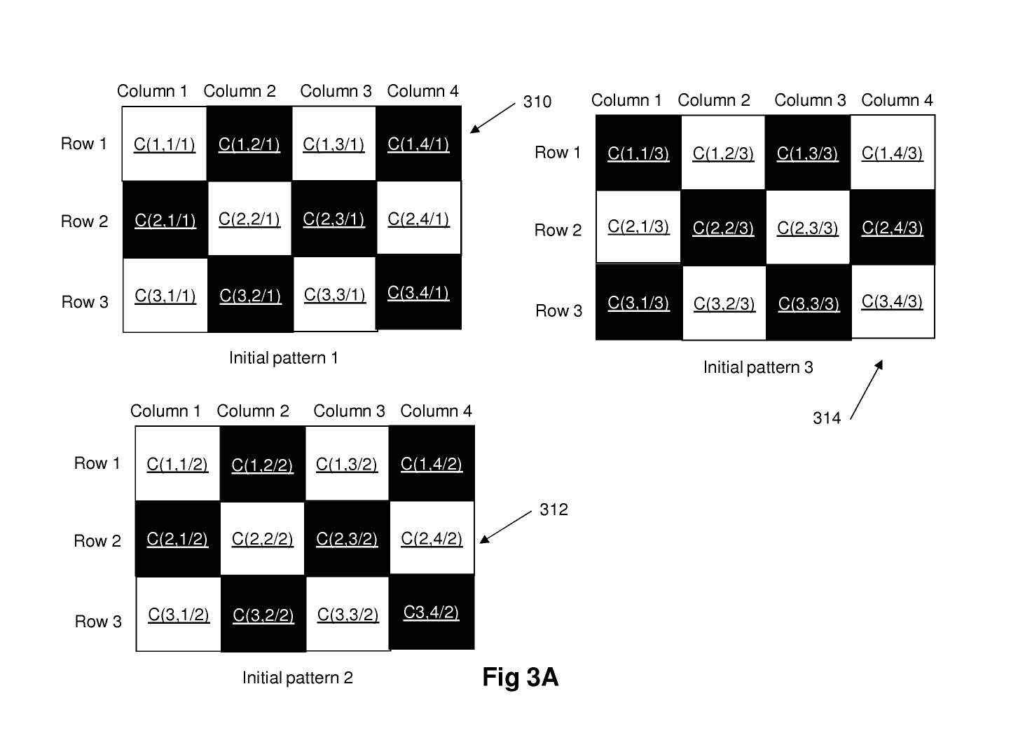

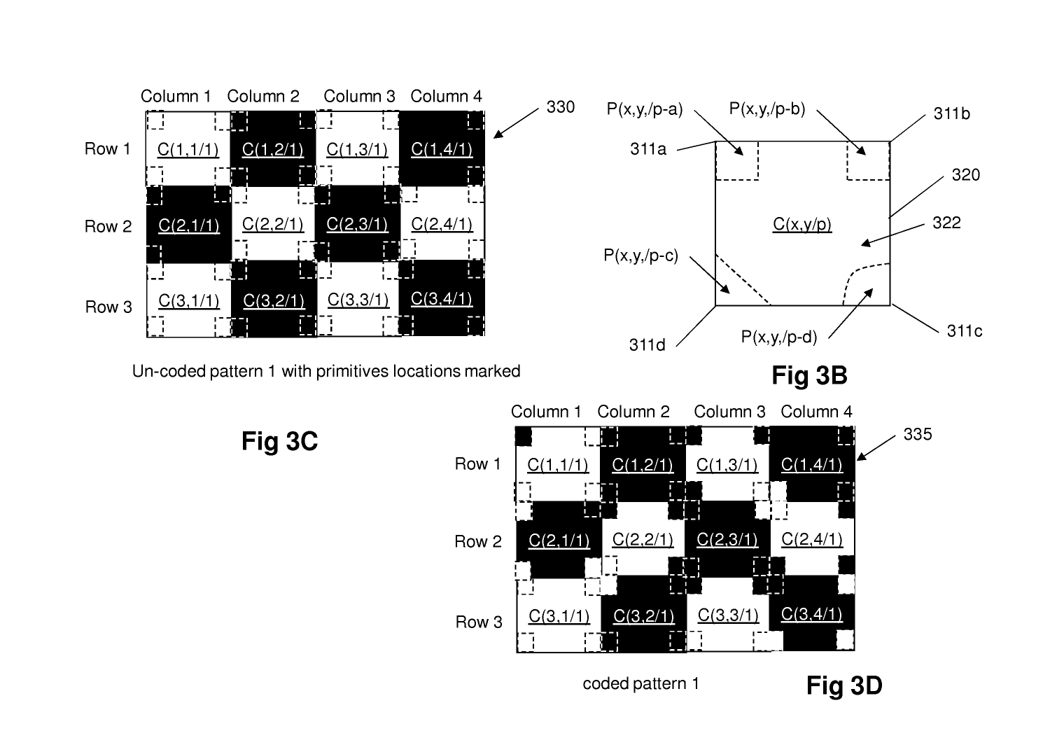

In contrast to spatial-coding approaches discussed in the background section above, embodiments of the current invention enable each cell in the pattern to become a distinguishable code-word by itself while substantially increasing the number of unique code-words (i.e. index-length), using the following encoding procedure: A cell of the first light-pattern has one or more overlapping cells in the other patterns of different wavelengths. Once the different light-patterns have been reflected from the scene and acquired by the imaging-sensors, a computer program implementing an instruction set can decode the index of a cell by treating all the overlapping elements in that cell as a code-word (e.g. a sequence of intensity values of elements from more than one of the overlapping patterns). Explicitly, FIGS. 3A-D schematically depicts a section of an exemplary pattern constructed in accordance with the specific embodiment.

FIG. 3A schematically depicts an initial (un-coded) pattern used as a first step in the creation of a coded pattern. In the example only four cells (cells 1, 2, 3, and 4) of three rows (Row 1, 2 and 3) of each of the three patterns (pattern 1, 2, 3) that are combined to form the entire projected pattern are shown.

The projected image, projected by projection unit 15 comprises three patterns (pattern 1, pattern 2 and pattern 3), created by the different masks 3x respectively, and each with a different wavelength. The three patterns are projected concurrently on the scene by projection unit 15 such that the corresponding cells are overlapping. That is: cell C(1,1/1) which is cell 1 of Row 1 in pattern 1 is overlapping cell C(1,1/2) which is cell 1 of Row 1 in pattern 2, and both overlap cell C(1,1/3) which is cell 1 of Row 1 in pattern 3, etc.

According to an exemplary embodiment depicted example of FIGS. 3A-D, each “pattern cell” is indicated as C(y,x/p), wherein “y” stands for row number, “x” for cell number in the row, and “p” for pattern number (which indicates one of the different wavelength). To construct the coding pattern, cells in each pattern are initially colored in a chessboard pattern (310, 312 and 314) of alternating dark (un-illuminated) and bright (illuminated) throughout. In the example depicted in FIG. 3A, the Initial pattern 1 comprises: bright cells C(1,1/1), C(1,3/1), . . . , C(1, 2n+1/1) in Row 1; C(2,2/1), C(2,4/1), . . . , C(2, 2n11) in Row 2; etc. while the other cells in Initial pattern 1 are dark. The other patterns (Initial patterns 2 and 3) are similarly colored. It should be noted that optionally, one or both patterns 2 and 3 may be oppositely colored, that is having dark cells overlapping the bright cells of Initial pattern 1 as demonstrated by Initial pattern 3 (314).

FIG. 3B schematically depicts coding a cell in a pattern by an addition of at least one coding element to the cell according to an exemplary embodiment of the current invention.

Each of the cells in a pattern, such as cell 320, has four corners. For example, cell C(x,y/p) 320 has upper left corner 311a, upper right corner 311b, lower right corner 311c and lower left corner 311d. In an exemplary embodiment of the invention, the cell is coded by assigning areas (coding elements P(x,y,/p-a), (x,y,/p-b), (x,y,/p-c), and (x,y,/p-d) for corners 311a, 311b, 311c, and 311d respectively) close to at least one of the corners, and preferably near all four corners, and coding the cell by coloring the area of the coding elements while leaving the remaining of the cell's area 322 (primitives) in its original color.

In the example depicted in FIGS. 3A-D, coding elements at the upper corners are shaped as small squares and the remaining cell's area 322 is shaped as a cross. It should be noted that coding elements of other shapes may be used, for example triangular P(x,y/p-c) or quarter of a circle (quadrant) P(x,y/p-d), or other shapes as demonstrated. The remaining cell's area 322 retains the original color assigned by the alternating chessboard pattern and thus the underlying pattern of cells can easily be detected.

FIG. 3C schematically depicts a section 330 of Un-coded pattern 1 shown in FIG. 3A with coding elements (shown with dashed-line borders) shaped as small squares according to an exemplary embodiment of the current invention.

FIG. 3D schematically depicts a section 335 of coded pattern 1 shown in FIG. 3C according to an exemplary embodiment of the current invention.

In this figure, the color of a few of the coding elements was changed from the cell's original color. For example, the upper left coding element of cell C(1,1/1) was changed from the original bright (as was in 330) to dark (as in 335). Note that since each cell may comprise four coding elements in this example, the index length for a cell is 2⁴=16 for each pattern, and 16³=4,096 for a three wavelengths combination.

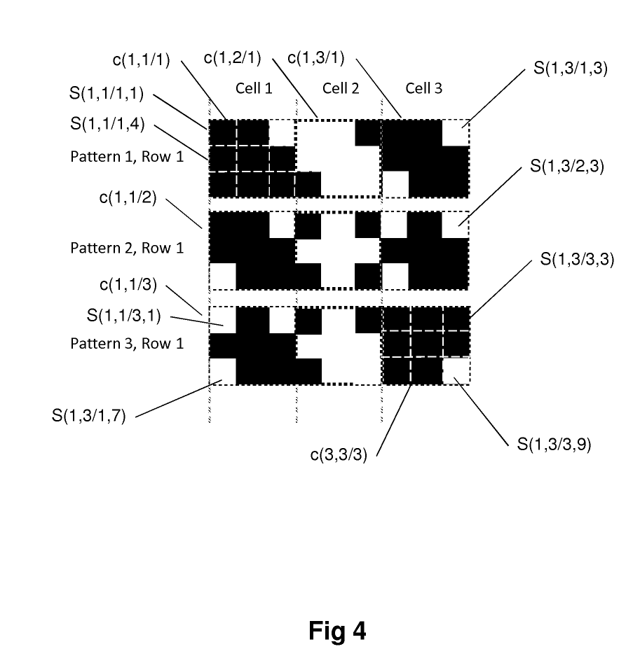

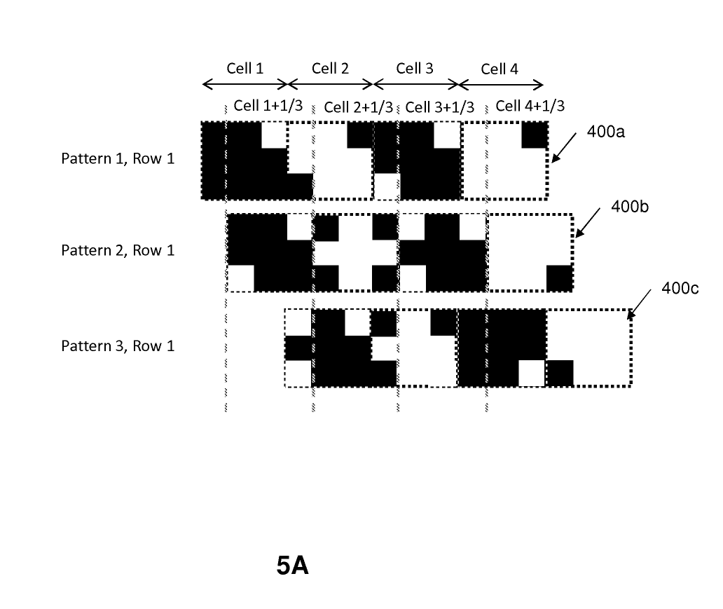

FIG. 4 schematically depicts a section of an exemplary coded pattern used in accordance with an exemplary embodiment of the current invention.

In this figure, only three cells (cells 1, 2, and 3) of one row (Row 1) of the entire projected pattern are shown one above the other. More specifically, the projected beam, projected by projection unit 15 (shown in FIG. 2B), comprises three patterns (Pattern 1, Pattern 2 and Pattern 3) created by the different masks 3x respectively, each with a different wavelength. The three patterns are projected concurrently onto the scene by projection unit 15 such that the corresponding cells overlap. That is: cell c(1,1/1) which is Cell 1 of Row 1 in Pattern 1 is overlapping Cell c(1,1/2), which is Cell 1 of Row 1 in Pattern 2, and both overlap Cell c(1,1/3) which is Cell 1 of Row 1 in Pattern 3, etc.

Each pattern cell c(y,x/p) comprises a plurality of subunits (coding elements), in this exemplary case, an array of 3×3=9 small squares S(y,x/p,j) (e.g. pixels) where “y”, “x”, and “p” are row, cell and pattern indices, and “j” is the index of the small square (element) (j=1, 2, 3, . . . , 9 in the depicted embodiment)

For clarity, only few of the small squares are marked in the figures. In the depicted example, the upper left small square of Cell 1 in Row 1 is illuminated only in pattern 3, that is illuminated by the third wavelength only, as indicated by dark S(1,1/1,1) and S(1,1/2,1) and bright S(1,1/3,1). While the upper right small square of Cell 3 in Row 1 is only illuminated in Patterns 1 and 2, that is illuminated by the first and second wavelengths, as indicated by a dark S(1,3/3,3), and bright S(1,3/2,3) and S(1,3/1,3).

Decoding (identifying and locating) cells in the imaged patterns (to be matched with the projected pattern and triangulated) may then be achieved by a computing unit executing an instruction set. For example, cells may be identified by the combined arrangement of elements (code-letters) of two or more overlapping patterns as follows. Considering, for clarity, only four cell elements—small squares located at the cell's corners, such as the four small squares S(1,1/1,1), S(1,1/1,3), S(1,1/1,7), and S(1,1/1,9) in Cell(1,1/1), a code-word for Cell 1 in FIG. 4 could be given by the sequence of binary element values (dark=0, bright=1) of three patterns overlapping in that cell: {0,1,0,0,0,1,1,0,1,1,1,0}, with the element order of {S(1,1/1,1), S(1,1/1,3), S(1,1/1,7), S(1,1/3,9), S(1,1/2,1), S(1,1/2,3), S(1,1/2,7), S(1,1/2,9), S(1,1/3,1), S(1,1/3,3), S(1,1/3,7), S(1,1/3,9)}.

The identified cells are then used by the computing unit in the triangulation process to reconstruct the 3D geometry of scene 77.

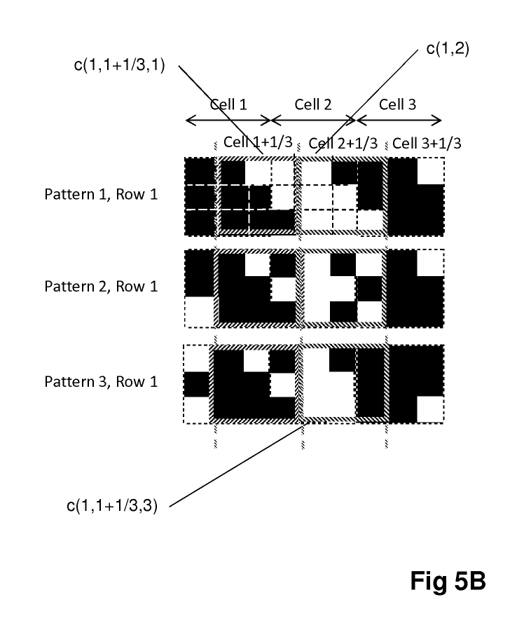

FIG. 5A schematically depicts a section of an exemplary pattern used according to another embodiment of the current invention.

Optionally, cell-rows in the different patterns may be shifted relative to one another for example by the size of one-third of a cell—the width of an element in this example. In the example shown in this figure, Pattern 2 (400b) is shown shifted by one third of a cell-width with respect to Pattern 1 (400a), and Pattern 3 (400c) is shown shifted by one third of cell-width with respect to Pattern 2 (400b), thereby coding cells as well as portions thereof (i.e. coding simultaneously Cells 1, 1+1/3, 1+2/3, 2, 2+1/3, 2+2/3, . . . , etc.).

Optionally, alternatively, or additionally, patterns are shifted row-wise, that is along the direction of the columns (not shown in this figure). The above mentioned cell-shifting can therefore yield a denser measurement of 3D scenes and may reduce the minimal size of an object that may be measured (i.e. radius of continuity).

Optionally, other fractions, of a cell's size may be used for shifting the patterns. The above mentioned cell-shifting can therefore yield a denser measurement of 3D scenes and reduces the minimal size of an object that may be measured (i.e. radius of continuity).

FIG. 5B schematically depicts a different encoding of a section of an exemplary pattern used in accordance with another embodiment of the current invention.

The projected patterns are identical to the patterns seen in FIG. 4. Optionally, pseudo-cells may be defined, shifted with respect to the original cells. For example, a pseudo-cell may be defined as the area shifted for example by one third of a cell-size from the original cell's location (as seen in FIG. 4). These pseudo-cells may be analyzed during the decoding stage by computing unit 17 and identified. In the example depicted in FIG. 5B, these pseudo-cells are marked in hatched lines and indicated (in Pattern 1) as c(1,1+1/3,1), c(1,2+1/3,1), etc. In the depicted example, cell c(1,1+1/3,1) includes the small squares (subunits) 2, 3, 5, 6, 8 and 9, of Cell 1 (using the notation of FIG. 4) and the small squares 1, 4, and 7 of Cell 2. Pseudo-cells c(1,1+2/3,1), c(1,2+2/3,1), etc., (not shown in the figure for clarity) shifted by the size of two elements, may be similarly defined to yield a measurement spacing of the size of an element-width.

Other fractions of cell-size may be used for shifting the pseudo-cell.

Optionally, alternatively, or additionally, pseudo-cells are shifted row-wise, that is along the direction of the columns

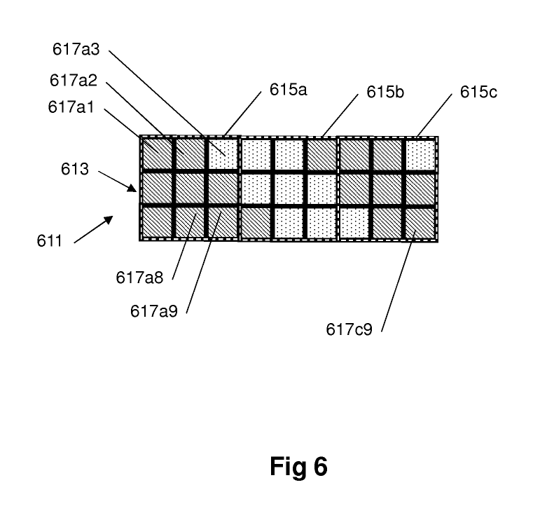

FIG. 6 schematically depicts another exemplary pattern used in according to an embodiment of the current invention.

The example in FIG. 6 shows a section 611 of one row 613 in projected pattern. In that section, there are three cells 615a, 615b and 615c (marked by a dotted line). Each cell 615x comprises nine small squares (subunits) marked as 617xy, wherein “x” is the cell index, and “y” is the index of the small square (y may be one of 1-9). For drawing clarity, only few of the small squares are marked in the figure. It should be noted that the number of small squares 617xy in cell 615x may be different from nine, and cell 615x may not be an N×N array of small squares. For example, each cell 671x may comprise a 4×4 array of small squares, a 3×4 array a 4×3 array, and other combinations.

The exemplary projected pattern shown in FIG. 6 has two wavelength arrangements, each represented by the different shading of the small squares 617xy. In the specific example, each small square is illuminated by one, and only one of the two wavelengths. For example, in cell 615a, small squares 1, 2, 4, 5, 6, 7, 8, and 9 (denoted by 617a1, 617a2, etc) are illuminated by a first wavelength; while small square 3 (denoted by 617a3) is illuminated by a second wavelength.

Similarly in cell 615b, small squares 3, and 7 (not marked in the figure) are illuminated by the first wavelength; while small squares 1, 2, 4, 5, 6, 8 and 9 are illuminated by the second wavelength.

Thus, a single row 613, projected onto the scene appears as a single illuminated stripe when all wavelengths are overlaid in a single image (i.e. an image constructed from the illumination by all wavelengths), and may be detected and used in line-scanning techniques used in the art. However, in contrast to methods of the art that use a projected solid line, the exact location of each cell on the stripe may be uniquely determined by the code extracted from the arrangement of the illumination of elements by the different wavelengths, even when gaps or folds in the scene create a discontinuity in the stripe reflected from the scene as seen by the camera. To scan the entire scene, using the improved line scanning technique disclosed above, the projected patterned strip 613 may be moved across the scene by projector unit 15. Optionally, projected patterns comprising a plurality of projected stripes are used simultaneously, yet are separated by gaps of unilluminated areas, and each is treated as a single stripe at the decoding and reconstruction stage.

Alternatively, the projected image may comprise a plurality of cell-rows that together form an area of illumination which enables measuring a large area of the surface of the scene at once (i.e. area-scanner), while retaining the indices for the cells.

Optionally, a third (or more) wavelength may be added, and similarly coded. When three or more wavelengths are used it may be advantageous to code them in such a way that each location on strip 613 is illuminated by at least one wavelength.

In an exemplary embodiment, the requirement is that each small square (as seen in FIG. 6) is illuminated by at least one wavelength. In the case of three wavelengths, each small square may be illuminated in one of seven combinations of one, two, or all three wavelengths, and the index length of a 3×3 small-squares cell is 7⁹, which is just over 40 millions.

In another exemplary embodiment, different index-lengths may be used in different patterns.

For example, assuming there are three patterns of different wavelengths, the index length for each element in a cell is 2³=8, and the total index length for each cell is 8⁹, or over 130 million permutations. This number is much larger than the number of pixels in a commonly used sensor array, thus the code might not have to be repeated anywhere in the projected pattern. Alternatively, the number of coding elements in each cell may be smaller. For example, if each cell comprises an array of 2×3=6 coding elements, the number of permutations will be 8⁶=262,144.

In another exemplary embodiment, the plurality of projectors 14x in projecting unit 15 (FIG. 2B) are replaced with: a broad spectrum light source capable of producing a beam having a broad spectrum of light; a beam separator capable of separating light from said broad spectrum light source to a plurality of partial spectrum beams, wherein each partial spectrum beam is having a different wavelength range; a plurality of masks, wherein each mask is capable of receiving a corresponding one of said partial spectrum beams, and capable of coding the corresponding one of said partial spectrum beams producing a corresponding structured light beam; a beam-combining optics, which is capable of combining the plurality of structured light beams, coded by the plurality of masks into a combined pattern beam 5.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

Specifically, wherever plurality of wavelengths are used for coding or decoding patterned light, polarization states may be used, or polarization states together with wavelengths may be used.

1-24. (canceled)

25. A system for non-contact measurement of 3D geometry comprising:
a projection unit comprising a plurality of projectors, each comprising a light source, capable of projecting concurrently onto a surface of a scene a plurality of structured patterns of light, wherein said patterns of light are at least partially overlapping, and wherein each of said patterns of light is substantially characterized by at least one parameter selected from a group consisting of wavelength and/or polarization state, and wherein said patterns of light are structured to encode a plurality of locations on said patterns of light based on the intensities of said patterns of light;
a light acquisition unit capable of concurrently capturing separate images of light patterns reflected from said surface of said scene, comprising a plurality of optical elements capable of splitting the light collected by said objective lens into separate light-patterns according to said parameter selected from a group consisting of wavelength and/or polarization state, and capable of directing each of said light-patterns onto the corresponding imaging sensor; and
a computing unit capable of processing said separate images captured by the light acquisition unit and capable of: decoding at least a portion of said plurality of locations on said patterns of light based on said images; determining the range to said surface of said scene based on triangulation of the decoded locations on said patterns of light; and reconstructing a 3D model of the said surface of said scene.

26. The system of claim 25, wherein each of said plurality of light sources is capable of producing a pulse of light, and said plurality of light sources are capable of synchronization such that pulses emitted from said light sources overlap in time.

27. The system of claim 26, wherein the wavelengths of said light sources are in the Near Infra Red range.

28. The system of claim 25, wherein said projection unit comprises:
a broad spectrum light source capable of producing a beam having a broad spectrum of light;
a beam separator, said beam separator is capable of separating light from said broad spectrum light source to a plurality of partial spectrum beams, wherein each partial spectrum beam is having a different wavelength range;
a plurality of masks, each mask is capable of receiving a corresponding one of said partial spectrum beams, and capable of coding the corresponding one of said partial spectrum beams producing a corresponding structured light beam; a beam combining optics capable of combining the plurality of structured light beams, coded by the plurality of masks into a combined pattern beam; and a projection lens capable of projecting said combined pattern beam onto at least a portion of the surface of said scene.

29. The system of claim 25, wherein said projection unit comprises:
a broad spectrum light source, capable of producing a beam having a broad spectrum of light;
at least one multi-wavelength mask, said multi-wavelength mask is capable of receiving the broad spectrum light from said a broad spectrum light source, and capable of producing multi-wavelength coded structured light beam of light by selectively removing from a plurality of locations on the beam light of specific wavelength range, ranges; and
a projection lens, capable of projecting said combined pattern beam onto at least a portion of the surface of said scene.

30. A method for non-contact measurement of 3D geometry comprising:
concurrently generating a plurality of structured patterns of light, wherein each of said plurality of structured patterns of light is substantially characterized by at least one parameter selected from a group consisting of wavelength and polarization state, and wherein said plurality of structured patterns of light are structured to encode a plurality of locations on said plurality of structured patterns of light, based on the intensities of said plurality of structured patterns of light;
projecting said plurality of structured patterns of light onto at least a portion of a surface of a scene, such that said plurality of structured patterns of light at least partially overlap on said surface and that at least a portion of said plurality of structured patterns of light is reflected off said portion of said surface of said scene;
capturing at least a portion of the light reflected off said portion of said surface of said scene;
guiding portions of the captured light to a plurality of imaging sensors, wherein each of said plurality of imaging sensors receives light substantially characterized by one of said parameters;
concurrently imaging light received by said imaging sensors; decoding at least a portion of said plurality of locations on said plurality of structured patterns of light based on images created by said imaging sensors;
reconstructing a 3D model of said surface of said scene based on the triangulation of the decoded locations on said plurality of structured patterns of light;
wherein said plurality of locations is coded by the combination of element arrangements of a plurality of overlapping patterns.

31. The method of claim 30, wherein said plurality of structured patterns of light comprises at least one row or one column of cells, wherein each cell is coded with a different location code from its neighboring cells.

32. The method of claim 31, wherein each one of said plurality of cells is coded with a unique location code.

33. The method of claim 30, wherein said plurality of structured patterns of light comprises a plurality of rows of cells.

34. The method of claim 31, wherein said plurality of rows of cells are contiguous to create a two dimensional array of cells.

35. The method of claim 30, wherein said plurality of adjacent cells are each entirely illuminated by at least one, or a combination, of the overlapping patterns of different wavelengths and/or polarity.

36. The method of claim 32, wherein one or more of the at least partially overlapping patterns are shifted relative to those of one or more of the other patterns each of said plurality of structured patterns of light is characterized by a different wavelength.

37. The method of claim 30, wherein at least one of the patterns consists of continuous shapes, and at least one of the patterns consists of discrete shapes.

38. The method of claim 35, wherein the discrete elements of different patterns jointly form continuous pattern shapes.

39. The method of claim 30, wherein said plurality of locations is coded by the sequence of element intensity values of a plurality of overlapping patterns.
